(19) United States
(12) Patent Application Publication
(10) Pub. No.: US 2019/0220946 A1
(43) Pub. Date: Jul. 18, 2019

(54) IMAGE READING DEVICE

(71) Applicant: KYOCERA Document Solutions Inc., Osaka (JP)

(72) Inventor: Yuya TAGAMI, Osaka (JP)

(73) Assignee: KYOCERA Document Solutions Inc., Osaka (JP)

(21) Appl. No.: 16/338,622

(22) PCT Filed: Dec. 18, 2017
(86) PCT No.: PCT/JP2017/045399

§ 371 Date: Apr. 1, 2019

(30) Foreign Application Priority Data
Dec. 21, 2016 (JP) 2016-248482

(51) Int. Cl. G06T 1/00; H04N 1/04; H04N 1/387; G06T 1/20

(52) U.S. Cl. CPC G06T 1/0007; G06T 1/20; H04N 1/387; H04N 1/04

(57) ABSTRACT

Provided are: a document reading section (5) reading a document loaded on a document base; an edge image detection section (102) detecting an edge image composed of continuous edge images from image data obtained through the reading by the document reading section (5); a document image extraction section (103) extracting, for each edge image detected by the edge image detection section (102), a document image from the edge image; and a determination section (104) determining whether or not an edge image having a predefined data amount or greater is present at an outside of the document image in the edge image from which the document image has been extracted by the document image extraction section (103), and upon determination by the determination section (104) that the edge image having the predefined data amount or greater is present at the outside, the document image extraction section (103) extracts a new document image from the outside.

### TECHNICAL FIELD

The present invention relates to an image reading device and more specifically to a technology of reading a plurality of documents loaded on a document base such as platen glass.

### BACKGROUND ART

Patent Document 1 below discloses that an image of a document loaded on a document base is detected by use of labeling processing of coupling together continuous pixels and regions and assigning a number to each of the regions with same properties. Patent Document 1 further discloses that a plurality of documents loaded on the document base is independently detected by use of the labeling processing.

### CITATION LIST

### Patent Literature

[Patent Document 1] Japanese Patent Application Laid-open No. 2005-057603

### SUMMARY OF INVENTION

However, in Patent Document 1 described above, detection of an image indicating each document where the plurality of documents are arranged closely to each other in a reading region is not supported sufficiently. For example, in a case where the documents are superposed on each other or in a case where the plurality of documents are connected to each other with contamination or dust present between, images indicating the two or more documents are treated as a single image, leading to possibility that a document image is not accurately detected.

In view of the circumstance described above, the present invention has been described, and it is an object of the invention to permit accurate detection of respective images of a plurality of documents loaded on a document base such as platen glass upon reading of the documents.

An image reading device according to one aspect of the invention includes: a document reading section reading a document loaded on a document base of a flatbed type; an edge image detection section detecting an edge image from image data obtained through the reading by the document reading section; a linked image detection section detecting a linked image obtained through linkage as one cluster from the image data which has been obtained through the reading by the document reading section and from which the edge image has been detected by the edge image detection section; a document image extraction section extracting, as a document image, from the linked image detected by the linked image detection section, a rectangular image with four sides surrounded by an image indicating edges; and a determination section determining whether or not an edge image having a predefined data amount or greater is further present at an outside of the extracted document image in the linked image from which the document image has been extracted by the document image extraction section. Upon determination by the determination section that the edge image having the predefined data amount or greater is present at the outside, the document image extraction section extracts a new document image from the linked image.

### Advantageous Effects of Invention

According to the invention, for the single cluster image having an edge image, this single edge image is first detected as a document image, and upon determination that an edge image is further present at the outside of the document image in the aforementioned cluster image, this edge image is further extracted as a new document image. Therefore, even upon reading of the two or more documents as one cluster image, respective images of the documents can accurately be detected.

### BRIEF DESCRIPTION OF DRAWINGS

FIG. 1 is a functional block diagram schematically illustrating main inner configuration of an image forming apparatus including an image reading device according to a first embodiment of the present invention.

FIG. 2 is a flowchart illustrating one example of processing operation performed at a control unit in the image forming apparatus including the image reading device according to the first embodiment.

FIG. 3 is a flowchart illustrating one example of the processing operation performed at the control unit in the image forming apparatus including the image reading device according to the first embodiment.

FIGS. 4A and 4B are views each illustrating one example of a state in which a plurality of documents are loaded on a document base with FIG. 4A illustrating a state in which the documents are separated from each other and FIG. 4B illustrating a state in which the documents are attached to each other with dust present therebetween.

FIGS. 5A and 5B are views illustrating edge images with FIG. 5A illustrating the state in which the documents are separated from each other and FIG. 5B illustrating the state in which the documents are attached to each other with the dust present therebetween.

FIG. 6 is a view illustrating relationship between the edge images and document images.

### DESCRIPTION OF EMBODIMENTS

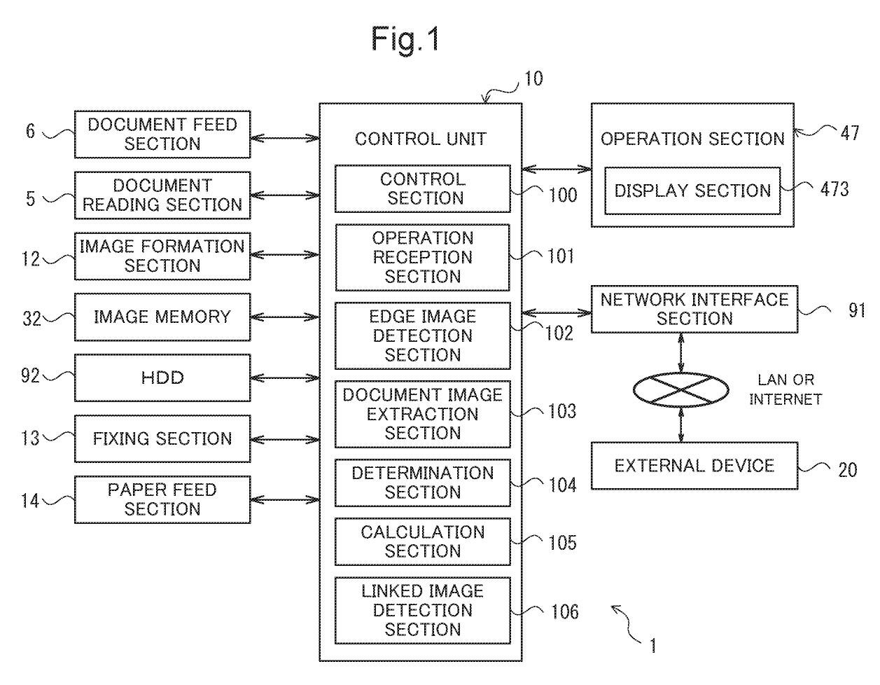

Hereinafter, an image reading device according to one embodiment of the present invention will be described with reference to the drawings. FIG. 1 is a functional block diagram schematically illustrating main inner configuration of an image forming apparatus including an image reading device according to a first embodiment of the invention.

The image forming apparatus 1 is a multifunctional peripheral combining together a plurality of functions such as, for example, a copy function, a printer function, a scanner function, and a facsimile function. The image forming apparatus 1 includes: a control unit 10, a document feed section 6, a document reading section 5, an image formation section 12, an image memory 32, a hard disk drive (HDD) 92, a fixing section 13, a paper feed section 14, an operation section 47, and a network interface section 91.

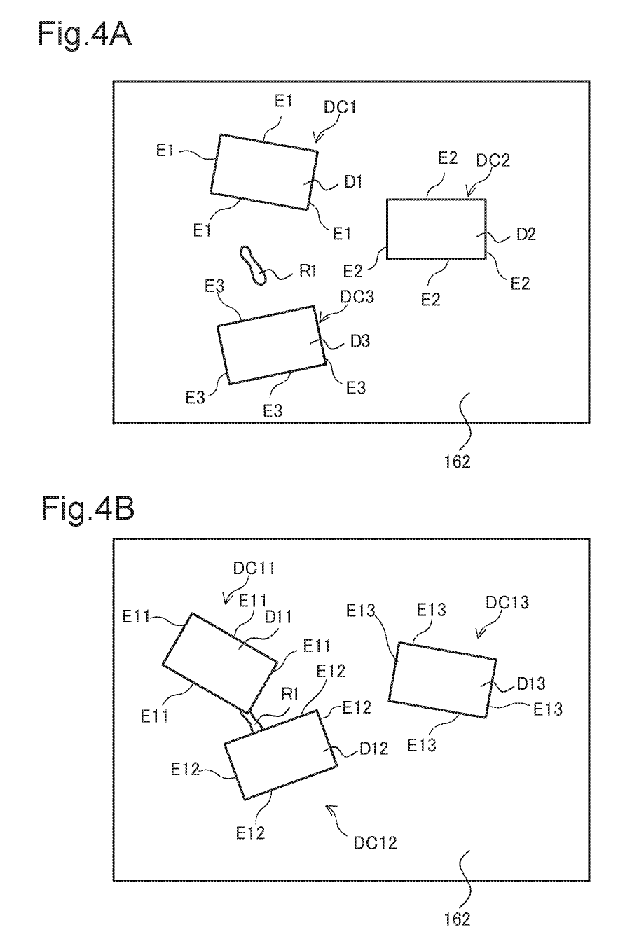

The document feed section 6 feeds a document to be read to the document reading section 5. The document reading section 5 irradiates the document fed from the document feed section 6 or a document loaded on a document base 162 (see FIG. 4) by use of a light irradiation section and receives light reflected therefrom to thereby read an image from the document. Image data obtained through the reading by the document reading section 5 is stored into, for example, the image memory 32.

The image formation section 12 forms, on paper (recording medium), a toner image of an image to be printed. The image memory 32 is a region for temporarily storing the image data of the document obtained through the reading by the document reading section 5 and for temporarily saving data to be printed by the image formation section 12.

The HDD 92 is a large-capacity storage device which stores, for example, a document image read by the document reading section 5. The fixing section 13 fixes, on the paper through thermal compression, the toner image formed on the paper. The paper feed section 14 includes a paper feed cassette (not illustrated) and picks up and conveys paper stored in the paper feed cassette.

The operation section 47 receives, from an operator, instructions such as an image formation operation execution instruction and a document reading operation execution instruction for various types of operation and processing executable by the image forming apparatus 1. The operation section 47 includes a display section 473 which displays, for example, an operation guide to an operator. The display section 473 is a touch panel, and the operator can touch a button or a key displayed on a screen to operate the image forming apparatus 1.

The network interface section 91 performs various types of data transmission and reception to and from an external device 20 such as a personal computer in a local area or on the Internet.

The control unit 10 includes: a processor, a random access memory (RAM), a read only memory (ROM), and a dedicated hardware circuit. The processor is, for example, a central processing unit (CPU), an application specific integrated circuit (ASIC), or a micro processing unit (MPU). The control unit 10 includes: a control section 100, an operation reception section 101, an edge image detection section 102, a document image extraction section 103, a determination section 104, a calculation section 105, and a linked image detection section 106.

The control unit 10 functions as the control section 100, the operation reception section 101, the edge image detection section 102, the document image extraction section 103, the determination section 104, the linked image detection section 106, and the calculation section 105 when the aforementioned processor operates in accordance with a control program stored in the HDD 92. However, the control section 100, etc. can also be formed by a hardware circuit without depending on the operation performed in accordance with the control program by the control unit 10. Hereinafter, the same applies to each embodiment unless otherwise is specified.

The control section 100 is in charge of overall operation control of the image forming apparatus 1. The control section 100 is connected to the document feed section 6, the document reading section 5, the image formation section 12, the image memory 32, the HDD 92, the fixing section 13, the paper feed section 14, the operation section 47, and the network interface section 91 and performs, for example, drive control of each of these sections.

The operation reception section 101 receives operation input from a user via the operation section 47.

The edge image detection section 102 executes edge detection processing on the image data obtained through the reading by the document reading section 5 and detects an edge image.

The linked image detection section 106 detects a linked image obtained through linkage as one cluster from the image data which has been obtained through the reading by the document reading section 5 and from which the edge image has been detected by the edge image detection section 102. The linked image detection section 106 detects, as the linked image, an image formed by connecting a plurality of pixels in the read image data described above.

The document image extraction section 103 extracts, as the document image from the linked image detected by the linked image detection section 106, a rectangular image with four sides surrounded by the edge image.

The determination section 104 determines whether or not an edge image having a predefined data amount M1 or greater is present in a region other than the extracted document image described above (at an outside of the document image) in the linked image obtained after the document image extraction by the document image extraction section 103. Note that the predefined data amount M1 is, for example, a data amount of the edge image forming outer periphery of a rectangular image of a smallest size defined to be extractable by the document image extraction section 103, which is intended to prevent detection of such a small image that exhibits contamination or dust as the edge image. Upon determination by the determination section 104 that the edge image having the predefined data amount M1 or greater is present in the region other than the extracted document image, the document image extraction section 103 extracts a new document image from the aforementioned linked image.

The calculation section 105 calculates a position, a size, and inclination of the image indicating the document from the image with the four sides indicating outer periphery of the document image extracted by the document image extraction section 103.

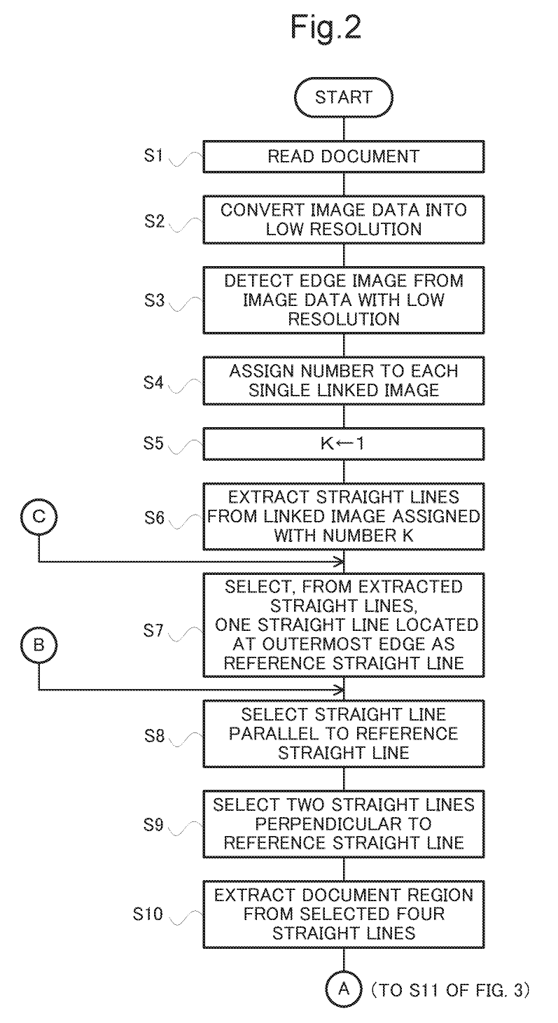

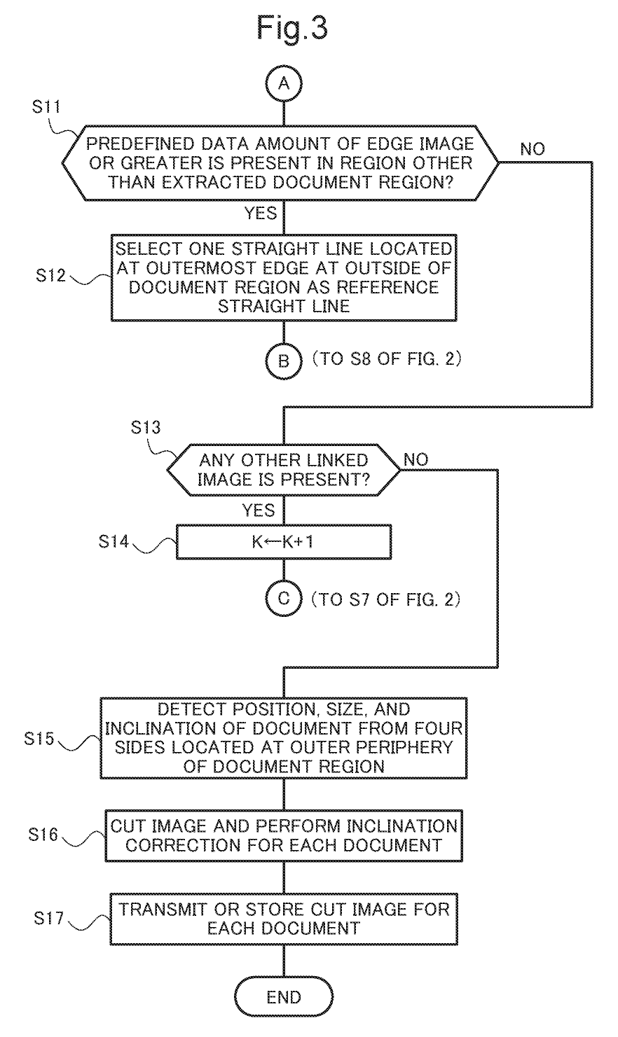

Next, processing of detecting the document image by the image reading device according to the first embodiment will be described based on flowcharts illustrated in FIGS. 2 and 3. Note that the processing of detecting the document image refers to processing performed in a case where the operation reception section 101 has received an instruction for reading the document loaded on the document base 162 of a flat bed type formed of platen glass or the like, which instruction has been provided from the user via the operation section 47.

First, the control section 100 causes the document reading section 5 to read the document loaded on the document base 162 with, for example, readable maximum resolution and causes the image memory 32 to store image data obtained through the reading by the document reading section 5 (S1).

Subsequently, the edge image detection section 102 executes image processing of converting the image data obtained through the reading by the document reading section 5 into low resolution (for example, 75 dpi) (S2). Further, the edge image detection section 102 detects the edge image from the image data converted into the low resolution (S3). The linked image detection section 106 detects linked images each formed of one cluster including the detected edge image and assigns a number to each of the detected linked images (S4). Note that the linked image detection section 106 does not detect, as a link, those which do not satisfy the predefined data amount M1 at this point. All the linked images detected here are subjected to the document image extraction processing performed by the document image extraction section 103. The conversion of the image data into the low resolution in S2 is intended to reduce processing loads imposed on the edge image detection section 102 upon the edge image detection processing performed in S2.

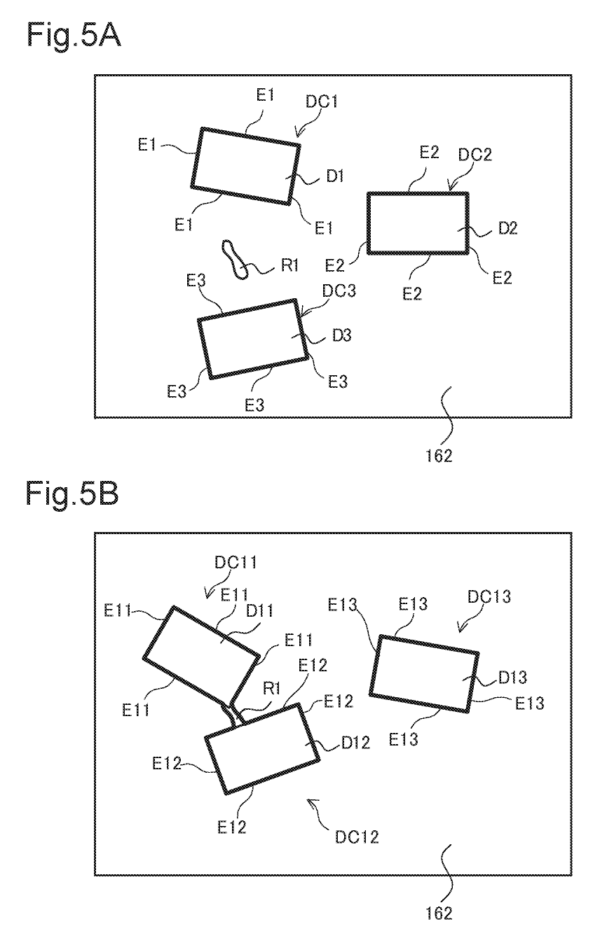

For example, a description will be given, referring to a case where a plurality of documents DC1 to DC3 are loaded on the document base 162 such as platen glass, dust R1 is present, and this is read by the document reading section 5, as illustrated in FIG. 4A. Based on image data obtained through this reading, the edge image detection section 102 respectively detects edge images E1 to E3 for document images D1 to D3 indicating the three documents, as illustrated in FIG. 5A. The linked image detection section 106 assigns a number “1” a to the document image D1, assigns a number “2” to the document image D2, and assigns a number “3” to the document image D3.

Moreover, for example, a description will be given, referring to a case where the plurality of documents DC11 to DC13 are loaded on the document base 162, the document DC11 and the document D12 are attached to each other with the dust R1 present therebetween, and this is read by the document reading section 5, as illustrated in FIG. 4B. Based on image data obtained through this reading, the linked image detection section 106 detects an image IM11 formed of the linked image indicating outer periphery of one cluster composed of the document DC11, the document DC12, and the dust R1, and the document image D13, as illustrated in FIG. 5B. In this case, the edge image detection section 102 assigns a number “1” to the image IM11 and assigns a number “2” to the document image D13.

Returning to FIG. 2, the document image extraction section 103 subsequently sets, at 1, a number K for specifying an image to be processed (S5) and, for example, masks the edge image included in the image to which a number matching the number K (=1) is assigned and extracts straight lines (linear components) (S6). The document image extraction section 103 selects, from the extracted straight lines, one straight line located at an outermost edge as a reference straight line (S7). The document image extraction section 103 further selects, from the extracted straight lines, a straight line parallel to the reference straight line and two straight lines perpendicular to the reference straight line (S8 and S9).

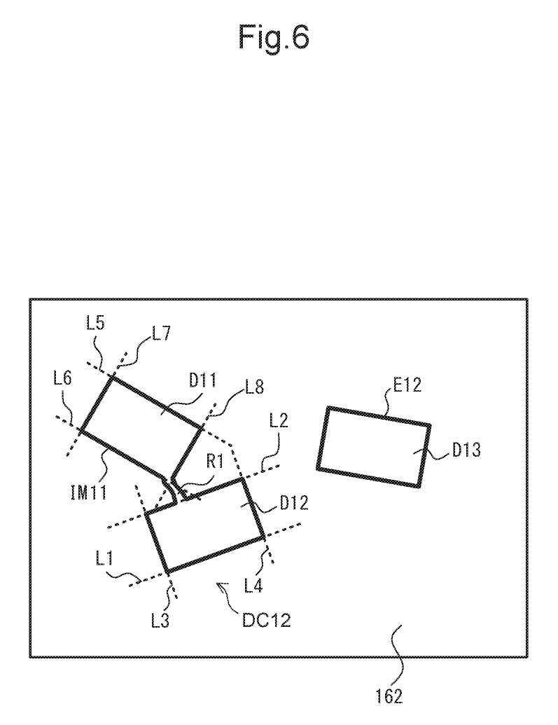

For example, as illustrated in FIG. 6, in a case where the image IM11 and the document image D13 are present in the read image data, the document image extraction section 103 selects, from the straight lines extracted from the image IM11 which is assigned with the number “1”, the straight line L1 located at the outermost edge of this image as the reference straight line. In this case, the document image extraction section 103 selects the straight line L2 as the straight line parallel to the straight line L1 and selects the straight lines L3 and L4 as the two straight lines perpendicular to the straight line L1.

Then the document image extraction section 103 extracts, as the document image, a rectangular image composed of the selected four straight lines (S10). For example, the document image extraction section 103 extracts, as the document image D12 of the document DC12, the rectangular image composed of the selected four straight lines L1 to L4 illustrated in FIG. 6.

Subsequently, the determination section 104 determines whether or not a total data amount of the edge image present in the region other than the document image in the linked image from which the document image has already been extracted by the document image extraction section 103 is equal to or greater than the predefined data amount M1 (S11).

Upon determination by the determination section 104 that the total data amount of the edge image is equal to or greater than the predefined data amount M1 (YES in S11), the document image extraction section 103 selects, as a new reference straight line, one straight line located at the outermost edge in the aforementioned edge image from among the straight lines extracted in S7 excluding the straight line corresponding to the edge image already extracted as the document image (S12). For example, as illustrated in FIG. 6, in a case where the rectangular image composed of the four straight lines L1 to L4 has already been extracted as the document image at this point, the document image extraction section 103 selects the straight line L5 as a new reference straight line.

Then returning to S8, the document image extraction section 103 selects the straight line L6 as the straight line parallel to the straight line L5 (S8), selects the straight lines L7 and L8 as the two straight lines perpendicular to the straight line L5 (S9), and extracts a rectangular image composed of the selected four straight lines L5 to L8 as the document image D11 indicating the document DC11 (S10).

On the other hand, upon determination by the determination section 104 in S11 that the total data amount of the edge image is not equal to or greater than the predefined data amount M1 (NO in S11), the document image extraction section 103 determines whether or not any other linked image from which the document image is to be extracted is further present in the image data obtained through the reading performed in S1 (S13). Note that in a case where the processing in S11 is a second trial or beyond, the determination section 104 determines whether or not a total data amount of other edge images excluding the edge image indicating an outline of the already extracted document image, as the total data amount of the edge image described above, is equal to or greater than the data amount M1.

Upon determination that any other linked image from which the document image is to be extracted is present, that is, upon determination that any other linked image assigned with the number through the labeling processing in S4 is present (YES in S13), the document image extraction section 103 adds 2 to the number K (S14), returning to S7. In this case, for example, in case of an example illustrated in FIG. 6, upon completion of processing of extracting the document image for the image IM11 assigned with the number “1”, the document image extraction section 103 next performs processing of extracting a document image on the document image D13 assigned with the number “2” matching the number K=2.

On the other hand, upon determination by the document image extraction section 103 that any other linked image from which the document image is to be extracted is not further present in the image data obtained through the reading performed in S1 (NO in S13), the calculation section 105 calculates a position, a size, and inclination of each document image from four sides as the outer periphery of the document image for each document image extracted by the document image extraction section 103 (S15).

Subsequently, the document image extraction section 103 cuts, based on the position and the size calculated by the calculation section 105, individual images that are independent for each document from the image data with high resolution stored in the image memory 32, and performs, based on the inclination calculated by the calculation section 105, inclination correction for each of the cut individual images (S16). Then the control section 100 transmits the image data of each document image extracted and corrected in the manner described above to the external device 20 (for example, a personal computer) via the network interface section 91 or causes the HDD 92 to store the aforementioned image data (S17).

According to the first embodiment described above, in a case where, for each one linked image labeled through the labeling processing described above, one document image is first extracted from the aforementioned image and further document image extraction is performed upon determination that a total data amount of each edge image present in the region of the aforementioned image other than the aforementioned document image is equal to or greater than the predefined data amount M1. Therefore, even when the two or more documents are read as one cluster, the respective images of the documents can accurately be detected.

Moreover, described in the first embodiment above is that the control section 100 individually transmits each of the extracted and corrected document images to the external device 20, but as another embodiment, the control section 100 may cause the image formation section 12 to perform image formation on a recording medium for each of the extracted and corrected document images on an individual image basis.

Moreover, the invention is not limited to the configuration of the embodiments described above and various modifications can be made thereto. In addition, the embodiments have been described above, referring to the multifunction peripheral as one embodiment of the image reading device according to the invention, but this is only one example and may be, for example, a scanner device.

Moreover, each of the configuration and processing illustrated by the embodiments described above with reference to FIGS. 1 through 6 is only one embodiment of the invention and the invention is not limited to the aforementioned configuration and processing.

1. An image reading device comprising:
a document reading section reading a document loaded on a document base of a flat bed type;
an edge image detection section detecting an edge image from image data obtained through the reading by the document reading section;
a linked image detection section detecting a linked image obtained through linkage as one cluster from the image data which has been obtained through the reading by the document reading section and from which the edge image has been detected by the edge image detection section;
a document image extraction section extracting, as a document image, from the linked image detected by the linked image detection section, a rectangular image with four sides surrounded by an image indicating edges; and
a determination section determining whether or not an edge image having a predefined data amount or greater is further present at an outside of the extracted document image in the linked image from which the document image has been extracted by the document image extraction section, wherein
upon determination by the determination section that the edge image having the predefined data amount or greater is present at the outside, the document image extraction section extracts a new document image from the linked image.

2. The image reading device according to claim 1, wherein
the document image extraction section selects, from the edge image detected by the edge image detection section, a straight line located at an outermost edge and serving as a reference straight line, then selects, from extracted straight lines, a straight line parallel to the reference straight line and two straight lines perpendicular to the reference straight line, and extracts, as the document image, a rectangular image composed of the selected four straight lines.

3. The image reading device according to claim 1, wherein
the predefined data amount is defined as a data amount of an edge image forming outer periphery of a rectangular image of a smallest size defined to be extractable by the document image extraction section.

4. The image reading device according to claim 1, further including
a calculation section calculating a position, a size, and inclination of the document loaded on the document base from four sides located at outer periphery of the document image extracted by the document image extraction section.

5. The image reading device according to claim 4, further comprising
an image memory storing the image data obtained through the reading by the document reading section, wherein
the document image extraction section cuts, based on the position and the size calculated by the calculation section, individual images that are independent for each document from the image data stored in the image memory, and performs, based on the inclination calculated by the calculation section, inclination correction on each of the cut individual images.
